(19) United States
(12) Patent Application Publication
(10) Pub. No.: US 2013/0106103 A1
(43) Pub. Date: May 2, 2013

(54) FACE SEAL CONDUIT FITTING

(71) Applicants: ANDREW HORSFALL, CUYAHOGA FALLS, OH (US); VINCENT TRAINA, CONCORD TOWNSHIP, OH (US); ANTHONY CHIHILL, RICHFIELD, OH (US); DON LEVENGOOD, CHAGRIN FALLS, OH (US); RUSSELL DIEMER, KIRTLAND, OH (US)

(72) Inventors: ANDREW HORSFALL, CUYAHOGA FALLS, OH (US); VINCENT TRAINA, CONCORD TOWNSHIP, OH (US); ANTHONY CHIHILL, RICHFIELD, OH (US); DON LEVENGOOD, CHAGRIN FALLS, OH (US); RUSSELL DIEMER, KIRTLAND, OH (US)

(73) Assignee: TYLOK INTERNATIONAL, INC., EUCLID, OH (US)

(21) Appl. No.: 13/287,965

(22) Filed: Nov. 2, 2011

(51) Int. Cl. F16L 19/065

(52) U.S. Cl. 285/341; 285/339

(57) ABSTRACT

A fitting comprises a body with a generally flat first face, a gland with a generally flat second face, and a collet assembly adapted to be squeezed onto the outside of the conduit. A nut surrounds the gland and is adapted to engage the body, to force the first and second faces into sealing engagement with each other and to force the collet assembly into sealing engagement with a conduit and with an internal passage in the gland. When the nut is an advanced position, it engages the body, transmitting an axially compressive force to the first collet and pressing the forward end face of the gland against the rear end face of the body. When the nut is a retracted position, it has its forward end face no farther forward than the plane of the forward end face of the gland.

### TECHNICAL FIELD

The present disclosure relates fittings for conduits such as tubes and pipes, and in particular to a flare-less or grip type fitting with a face seal to join a conduit to another component.

### BACKGROUND

Flare-less and grip-type fittings use one or two collets (or ferrules) and a nut that cooperate with a body. A leak-proof seal is obtained as the collets are tightened onto a conduit through the axial thrust provided by the nut. The front collet provides a leak-proof seal when the nut and collets are drawn up a specified number of turns. The rear collet grips the conduit to prevent pull off. Other similar fittings use a single collet, and work in much the same way.

The body of a fitting is adapted not only to accept the conduit and nut from one end, but to be connected to another component at its opposite end. For this reason the body may have, for example, external or internal threads to join it to the other component, or a nipple for connecting it to a hose or a other conduit, or a fitting for a flare union.

In order to assemble a flare-less or grip-type fitting, it is necessary to insert an end portion of the conduit through the nut, through the collets, and into the body prior to tightening the nut. Once the collets are tightened onto the conduit, they cannot be removed easily, and disassembly of the fitting requires the conduit to be pulled out axially from the fitting body. This fact can make the use of flare-less and grip-type fittings difficult or impossible in some applications. For example, where a conduit must bend sharply, it may be impossible to install the conduit into mutually perpendicular fittings without bending and damaging the tube.

### SUMMARY

The present application discloses a fitting for connecting a conduit to another component. The fitting combines a collet-seal with the conduit and an O-ring face seal for connecting to the other component. The fitting comprises a body adapted to connect to the other component. The body has a passage therethrough for carrying a fluid, and the passage terminates at a generally flat first face transverse to the passage. The fitting also comprises a gland having a passage therethrough for carrying a fluid, and the passage through the gland terminates at a generally flat second face transverse to the passage. The first and second faces are proportioned to be positioned in sealing engagement and with the passage through the gland in fluid communication with the passage through the body. The gland has an internal passage for receiving an end portion of the conduit. The fitting further comprises a collet assembly proportioned to surround the conduit and adapted to be squeezed into sealing engagement with the outside of the conduit. A nut surrounds the gland and is adapted to engage the body, to force the first face and second face into sealing engagement with each other and to force the collet assembly into sealing engagement with the conduit and the internal passage in the gland. The nut is movable between advanced and retracted positions. When the nut is in the advanced position, it engages the body, transmitting an axially compressive force to the first collet and pressing the forward end face of the gland against the rear end face of the body. When the nut is in the retracted position, it has its forward end face no farther forward than the plane of the forward end face of the gland. The collet assembly and the gland may be captured at least partially within the nut.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 shows a fitting having features disclosed in this application including I'm not engaging a body to seal a gland to the body;

FIG. 2 is a cross sectional view of the fitting illustrated in FIG. 1 but showing the not backed off the body so the body and gland may be separated;

FIG. 3 is an exploded view of the fitting of FIG. 1;

FIG. 4 is a cross-sectional view of the fitting of FIG. 1 before it has been made up;

FIG. 5 is a cross-sectional view of the fitting of FIG. 4 after it has been made up;

FIG. 6 is a cross-sectional view of the fitting similar to that shown in FIGS. 1-5 but having a single collet.

FIG. 7 is a cross-sectional view of the fitting similar to that shown in FIGS. 1-5 but having a different collet;

FIG. 8 is a cross-sectional view of a fitting similar to that shown in FIG. 4 but having an alternate structure for capturing a collet assembly and gland within a nut; and

FIG. 9 is a cross-sectional view of a portion of a fitting similar to that of FIG. 4 but having a second alternate structure for capturing a collet assembly and gland within a nut.

### DETAILED DESCRIPTION

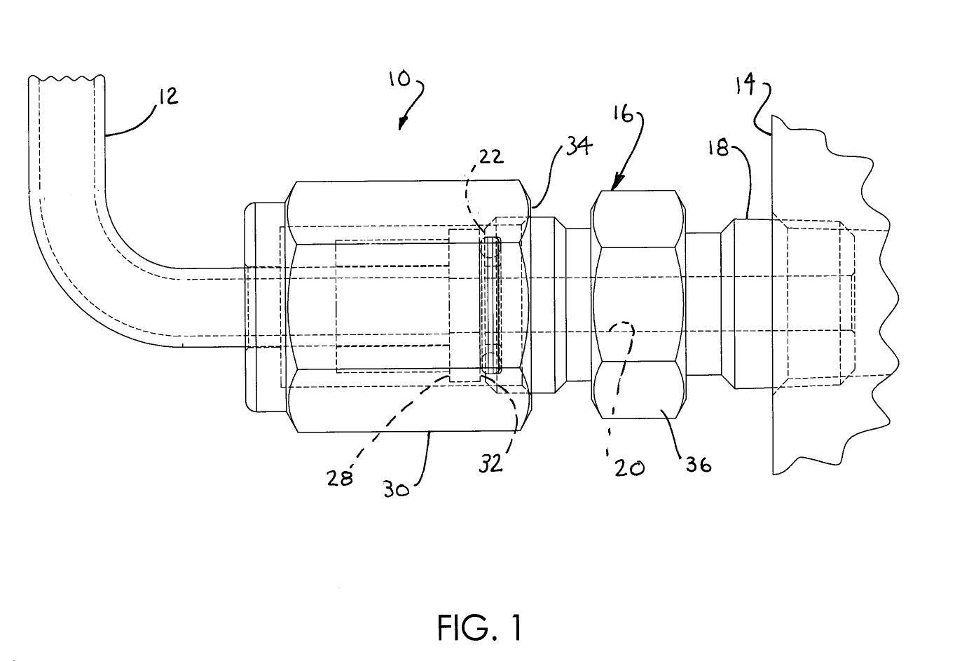

The fitting 10 shown in FIG. 1 is adapted to connect a conduit 12 to another component 14. To facilitate the description which follows, the terms “forward” and “rearward” or “front” and “rear” are used, but they are not intended to be limiting in any way. As viewed in FIG. 1, the rear of any piece is to the left, while the front is to the right, but this convention is intended only to make this description easier to read and understand.

The conduit 12 may be what is termed the “tube”, a “pipe”, or any other type of device for carrying fluid under pressure. The fluid may be a liquid or gas, a combination, or even a slurry. The fluid may be at a higher or lower pressure than ambient.

The component 14 can be any device or object to or from which fluid from the conduit 12 is to flow. As illustrated in FIG. 1, the fitting 10 includes a body 16 with a threaded end portion 18 which can be screwed into the component 14. However, the body 16 may be connected to the component 14 by other means, or many the integrally formed with it.

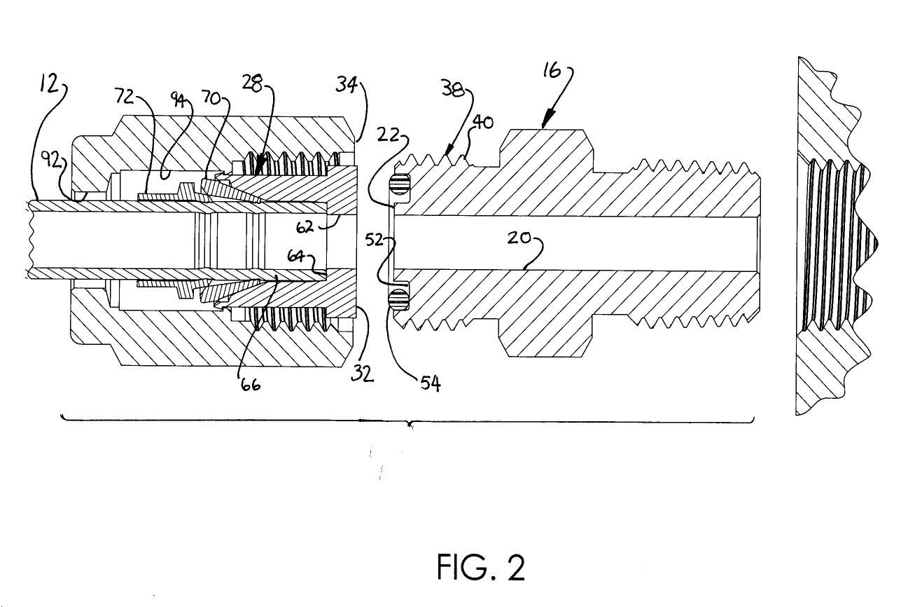

The fitting 10 includes the body 16, a gland 28, and a nut 30. The body 16 includes a central passage 20 and a rear end face 22 generally normal to the axis of passage 20. The gland 28 includes a front end face 32. The two interfaces 22 and 32 are proportioned to seat against each other. When the nut 30 is screwed onto the body (moving to the right in FIG. 1), the front end face 32 of the gland 28 is pulled tight against the rear end face 22 of body 16 to form a fluid tight seal between the gland 28 and the body 16. When the nut 30 is screwed off the body 16, the nut is free to slide along the conduit 12 (to the left or rear in FIG. 1.) The nut 10 can be retracted to the left as shown in FIG. 1 by sliding along the conduit 12 so that it's front end face 34 is to the rear of end face 22 of the body 16 as shown in FIG. 2, and in that condition, a conduit 12, nut 30, and gland 28 can slide laterally with respect to the body 16. As a consequence of being able to retract the nut 30 until it clears the body 16, the fitting 10 can be used in tight quarters. Axial movement of the conduit 12 is not required to separate conduit from the body 16.

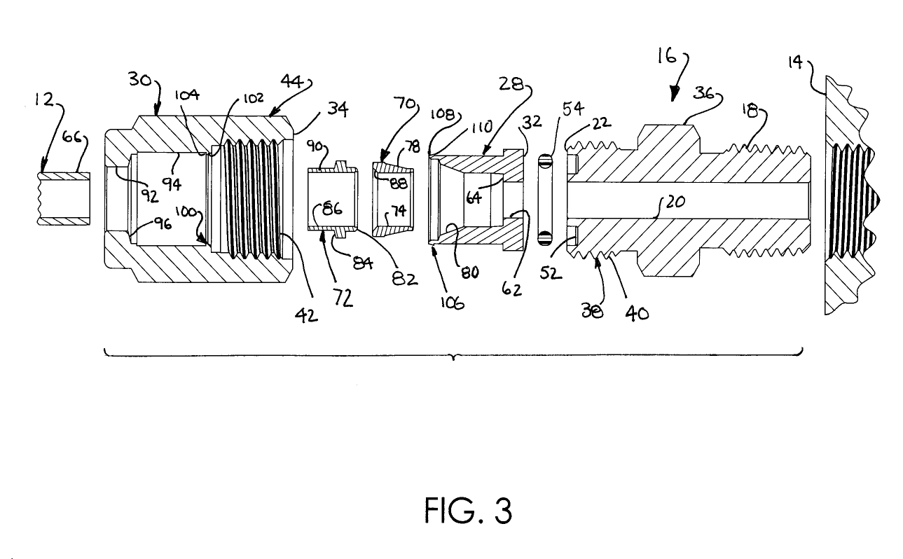

FIG. 3 shows the fitting 10 in an exploded cross-section view. The body 16 includes the central passage 20. The passage 20 carries fluid from the gland 28 to the component 14. The body 16 also includes an external hex surface 36 which facilitates screwing the threaded end portion 18 of the body into the component 14. In some applications the hex surface 36 may not be required, for example, where the body 16 is integrally formed with the component 14 or welded to it.

The rear end portion 38 of the body 16 includes threads 40. The threads 40 engage the threads 42 in the front end portion 44 of the nut 30. The threads 42 and 44 cooperate to pull the nut 30 over the body 16. The threads 42 and 44 may be replaced by any equivalent structure such as a pin and cam arrangement like those found in bayonet fittings.

The body 16 terminates at a rear end face 22. The rear end face 22 is generally flat and transverse to the axis of passage 20. Generally, the rear end face 22 may be normal to the axis of passage 22. An annular recess 52 is formed in the end face 22 to hold a resilient O-ring seal 54 which helps seal the gland 28 to the body 16.

The gland 28 has a forward end face 32 and a central passage 62. The forward end face 32 is generally flat and transverse to the axis of passage 62. Generally, the forward end face 32 may be normal to the axis of the passage 62. When the fitting 10 is made up by turning the nut 30 onto the body 16, the forward end face 32 of the gland 28 presses against the rear end face 22 of the body 16 and compresses the O-ring 54 to make a fluid tight seal between the gland and the body.

There are numerous types of face-to-face connections which may be used. The connection between the gland 28 in the body 16 may be of the type described in SAE 1453, but many others are known and may be required for particular applications. In some the forward end face 32 of the gland 28 and the rear end face 22 of the body 16 may be provided with interlocking ridges and grooves rather than being completely flat. These ridges and grooves may be circumferential to provide a seal, or radial to provide for a particular angular alignment. In addition, as noted above, the rear end face 22 of the body 16 and the forward end face 32 of the gland 28 may be inclined with respect to the axis of the central passage 62 through the gland 28 and the central passage 20 through the body 16.

An annular face 64 in passage 62 enlarges the diameter of the passage 62 so that it can accommodate an end portion 66 of the conduit 12. The annular face 64 limits forward movement of the conduit 12 as it is inserted into the gland 28.

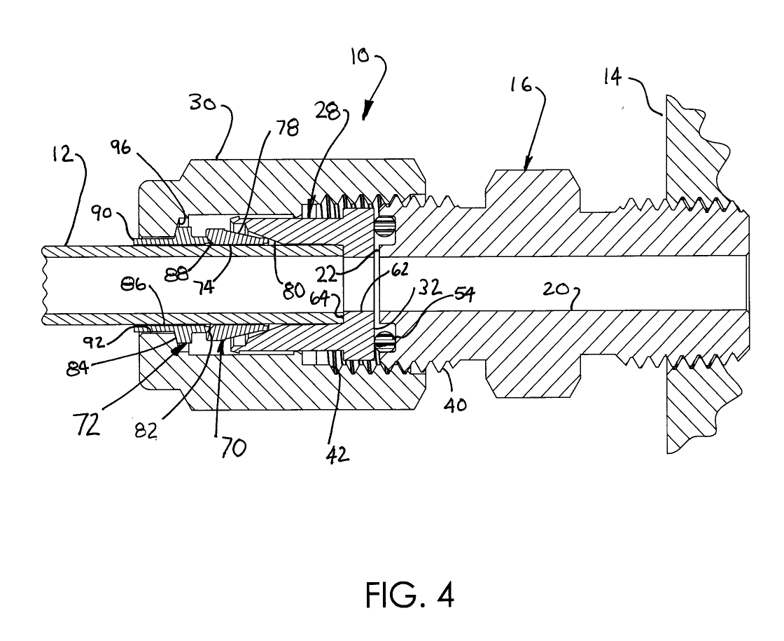

The fitting 10 may use two collets, front collet 70 and rear collet 72, to seal against the conduit 12 and to hold the conduit in place. The front collet 70 includes a cylindrical inside surface 74 that initially slides over the outside of the conduit 12, as shown in FIG. 4. The front collet 70 also includes an exterior tapered surface 78.

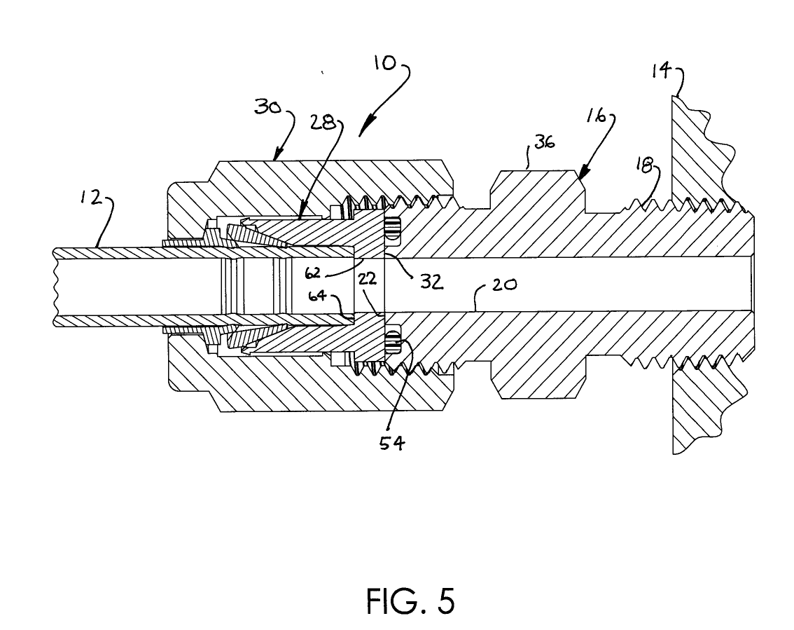

The gland 28 (FIG. 3) includes a tapered surface 80 which cooperates with the tapered surface 78 of the front collet 70. The tapered surface 80 is conical, opening outward as it extends rearward. When the front collet 70 is forced forward, it burnishes and then squeezes the conduit 12 forming a fluid tight seal as it is driven to the position shown in FIGS. 2 and 5.

The rear collet 72 (FIG. 3) includes a tapered front end portion 82, an annular shoulder 84, and a cylindrical inside surface 86. The inside surface 86 is proportioned to slide over the end portion 66 of the conduit 12 before the fitting 10 is made up for the first time, as shown in FIG. 4. During initial makeup of the fitting, the tapered front portion 82 of the rear collet 72 engages with a tapered entry passage 88 of the front collet 70 and is driven radially inward and bites into the conduit 12, preventing the conduit from being withdrawn. FIGS. 2 and 5 show the fitting 10 after it has been made up the first time.

The rear collet 72 may also include a tubular extension 90 which extends rearward from the annular shoulder 84. See FIG. 3. A tubular extension 90 has an outside diameter proportioned to fit through an opening 92 in the nut 30. The tubular extension 90 serves to keep the rear collet centered and also to protect the conduit 12 from abrasion as the nut 30 is rotated.

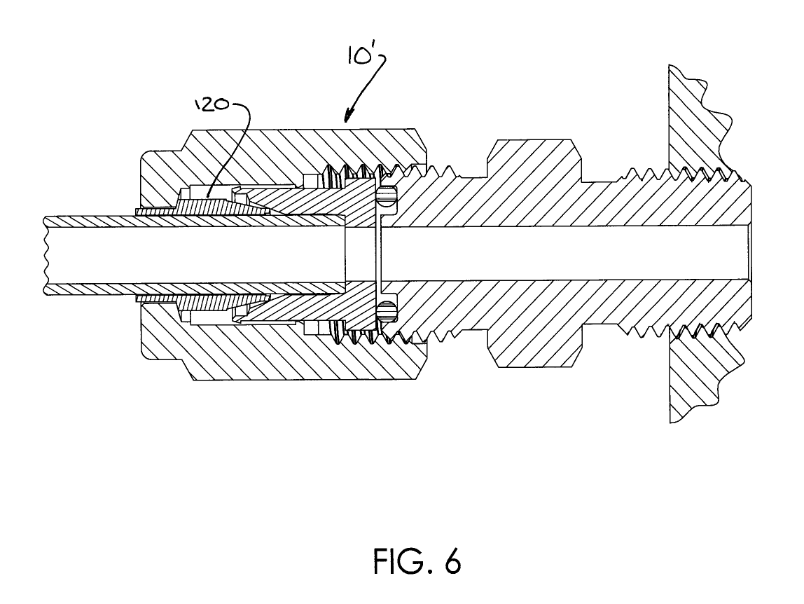

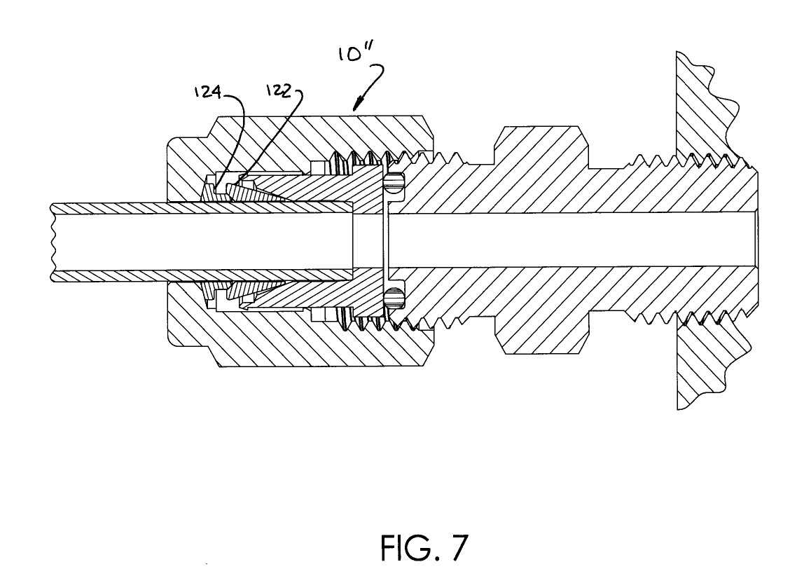

While the fitting 10 is described as using a front and rear collets 70 and 72, it is possible to use a single collet 120 in place of the front and rear collets, and single collet flare-less fittings are well known. Such a fitting 10′ is shown in FIG. 6. Other style collets may also be used, such as the collets 122 and 124 used in fitting 10″ shown in FIG. 7. The fittings 10′ and 10″ are identical to the fitting 10 except for the collets used in changes to the nut to accommodate the collets. They need not be described further.

As shown in FIG. 3, the nut 30 includes a central passage 94 forward of and larger than the rear opening 92. The rear opening 92 and the central passage 94 are connected by an inclined surface 96 which is parallel to the annular shoulder 84 of the rear collet and proportioned to engage the annular shoulder of the rear collet as the nut 30 is driven forward. The central passage 94 forms a cavity in which the front and rear collets 70 and 72 are located when the fitting 10 is assembled. The forward portion of the central passage 94 includes threads 42 which, as discussed above, cooperate with the threads 40 on the body 16.

Before assembly, the gland 28, nut 32, and front and rear collets 70 and 72 are free of each other. Loose collets and a gland may be hard to manipulate and install correctly. Therefore the gland 28 and nut 30 are designed to retain the collets 70 and 72 prior to initial makeup of the fitting 10. To this end, the central passage 94 in the nut 30 includes an annular ridge 100. The annular ridge 100 includes the tapered surface 102 which faces the front of the nut 30 and a stop surface 104 which faces to the rear. The annular ridge 100 in the nut 30 cooperates with a similar annular ridge 106 located at the rear end of the gland 28. The ridge 106 in the gland 28 includes a tapered surface 108 which faces rearward and a stop surface 110 which is more nearly perpendicular to the axis of the gland 28 and faces forward. The ridges 100 and 106 act as a one-way catch, allowing assembly but not disassembly of the nut 30 onto the gland 28.

To assemble the nut 30, collets 70 and 72, and gland 28, the front collet 70 is first placed in the gland 28 with the tapered surface 78 of the front collet 70 touching the tapered surface 80 of the gland. Next, the rear collet 72 is positioned with its forward tapered surface 82 in contact with the tapered surface 88 at the rear of the front collet 70. Thereafter the nut 30 is placed over the two collets 70, 72 and the gland 28. As the ridge 106 at the rear of the gland passes the rear end of the threads 42, the tapered surface 108 of the ridge 106 engages the tapered surface 102 of the ridge 100. A slight force is required to squeeze the ridge 106 past the ridge, facilitated by the two tapered surfaces 108 and 102 and the relatively thin section 112 at the rear of the gland 28. As the gland is forced further into the central passage 94 in the nut 30, the ridge 106 expands radially outward, and thereafter the stop surface 110 and the stop surface 104 on the gland 28 and nut 30, respectively, prevent the gland 28 from being removed. Thus the collets 70 and 72 and the gland 28 are captured within the nut 30, and it is therefore impossible to lose the two collets 70 and 72 without destructively removing the gland 28. The position of the ridge 106 and the ridge 102 are selected so that the stop surfaces 104 and 110 engage each other as the nut is being moved rearward only after the end face 34 of the nut 30 has moved rearward of the end face 60 of the gland 28, as shown in FIG. 2.

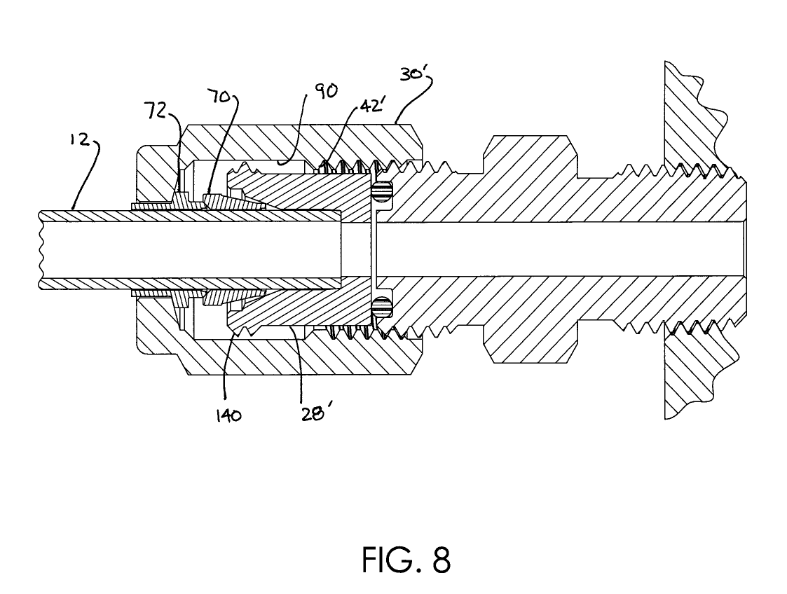

As an alternative to the ridges 100 and 106, a threaded arrangement may be used as shown in FIG. 8. Here the female threads 42′ in the nut 30′ extended rearward to join the passage 94. (The ridge 100 in the nut has been eliminated.) On the gland 28′, the ridge 106 has been replaced by male threads 140. The threads at 140 cooperate with the threads 42′. Because the male threads 140 have an outside diameter smaller than the inside diameter of the passage 94 through the nut 30, once the nut 30 has been screwed onto the gland 28′ by turning it through the required number of turns, the gland is free to move axially within the nut, and the collets 70 and 72 are captured within.

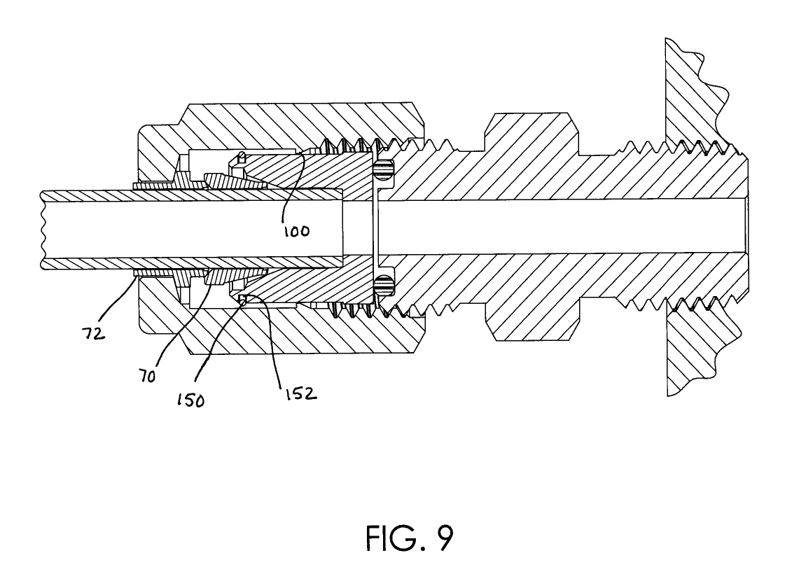

Another alternative to the ridges 100 and 106 is to replace one of them with a spring clip 150. FIG. 9. For example, the ridge 106 may be replaced with a annular recess 152 proportioned to receive the spring clip 150. When the ridge 100 is pressed past the spring clip 150, it cannot be removed, thus guaranteeing that the collets will be retained in place between the nut 30 and gland 28 prior to initial make up of the fitting 10. In a further variation, the ramp 100 and/or the ramp 106 may shaped to retain the gland but allow disassembly. This can be done, for example, by making the stop face 104 a ramp, symmetrical with the tapered surface 102.

Various techniques may be used to assure that the collets 70 and 72 remain properly aligned prior to insertion of the conduit 12 into the fitting 10 and initial makeup of the fitting on the conduit. One such arrangement is shown in FIG. 4. Here the body 16 has been threaded into the nut 30 until there is contact between the tapered surface 80 of the gland 28, the tapered surface 78 of the front collet 70, between the tapered surface 88 at the rear of the front collet and the tapered surface 82 at the front of the rear collet 72, and between the shoulder 89 on the rear collet and the tapered surface 96 in the nut. The contact should not involve an axial preload which might distort the collets making installation of the conduit 12 difficult.

Other techniques may also be used to hold the collets 70 and 72 in alignment with the passage 92 through the nut 30 and the passage 62 through the gland 28. These techniques include adhesives and/or lubricants to hold the collets 70 and 72 and gland 28 in proper orientation. One product that may be used is wax which may hold the collets 70 and 72 in place. The adhesive and/or lubricant may be applied as a coating or it may be foamed to full the entire space between the collets 70 and 72 and the nut 30 except for a passage where the tube 12 will be inserted. As an alternative, the tubular extension 90 of the rear collet 72 may be extended so that even when the gland 28 is in its forward most position, the tubular extension is housed within the rear opening 92 in the nut 30. In this case the tubular extension may be provided with a dimple which projects outwardly and contacts the passage 92 through the nut 30. Upon initial makeup of the fitting, the dimple is forced through the passage 92 in the nut, its purpose having been served.

To use the fitting 10, a conduit 12 is inserted through the opening 92 in the nut 30, through the passage 86 through the rear collet 72, through the passage 74 through the front collet 70, and into the gland 28 until the leading end face of the conduit 12 contacts the annular face 64 in the gland. See FIG. 4. The gland 28 is then placed with its front end face against the rear end face 22 of the body 16. The nut 30 is then turned to engage the threads 40, 42 to pull the nut forward. The inclined surface 96 in the nut forms a shoulder which engages the annular shoulder 84 of the rear collet 72, pushing it forward. The rear collet 72 in turn pushes the front collet 70 forward into the tapered surface 80 at the rear of the gland 28. As the nut 30 moves forward, the collets 70 and 72 slide along and then are compressed around and into the conduit 12, sealing against it. At the same time the front face 32 of the gland 28 is pressed against the rear face 22 of the body 16, compressing the O-ring 54 and effecting a seal between the gland and the body, as shown in FIG. 5. Thus a single nut 30 serves both to drive the collets 70 and 72 into sealing engagement with the conduit 12 and to pull the front face 32 against the rear face 22 of the body 16. It is noteworthy that a single operation, holding the body 16 against rotation while turning the nut 30, serves both to compress the collets 70 and 72 onto the conduit 12 and to seal the gland 28 against the body 16. In addition, the fitting 10 is axially compact, allowing it to be used in some applications where longer fittings or combinations of fittings cannot be used.

When it is necessary to disconnect the conduit 12 from the component 14, the nut 30 may be screwed back and then slid rearward until its end face 34 is rearward of the front face 32 of the gland 28, as shown in FIG. 2. This allows lateral movement of the gland 28 and nut 30 with respect to the body 16 with little or no axial movement of the forward end face 32 of the gland away from the rear end face 22 of body 16.

While the inventive principles have been illustrated by the description of various embodiments thereof, and while the embodiments have been described in considerable detail, it is not intended to restrict or in any way limit the scope of the appended claims to such detail. Additional advantages and modifications will be readily apparent to those skilled in the art. The invention in its broader aspects is therefore not limited to the specific details, representative apparatus, methods and examples shown and described. Accordingly, departures may be made from such details without departing from the scope or spirit of the general inventive principles.

1. A fitting comprising
a body extending along an axis and having a generally flat rear end face transverse to the axis of the body,
a gland having a central axis and a generally flat forward end face transverse to the axis of the gland and proportioned to seat against the rear end face of the body,
at least a first collet, and
a nut proportioned to surround the first collet and the gland and having a forward end face, the nut being movable between advanced and retracted positions, the nut in the advanced position engaging the body and transmitting an axially compressive force to the first collet and pressing the forward end face of the gland against the rear end face of the body, and the forward end face of the nut being no farther forward than the plane of the forward end face of the gland when the nut is in the retracted position, and
wherein the gland includes a first ridge and the nut includes a second ridge and the first and second ridges engage each other to limit axial movement of the nut with respect to the gland in a rearward direction.

2. The fitting of claim 1 wherein the body has threads and the nut has corresponding threads, whereby the nut can be screwed onto the body.

3. The fitting of claim 1 wherein one of the front end face of the gland and the rear end face of the body includes an annular recess.

4. The fitting of claim 3 further including a resilient ring received in the annular recess.

5. (canceled)

6. The fitting of claim in 1 wherein the gland includes a central passage proportioned to receive a conduit, and the passage includes a shoulder to limit axial movement of the conduit in the forward direction.

7. The fitting of claim 6 wherein the gland includes a tapered passage proportioned to receive the first collet.

8. The fitting of claim 1 further including a second collet, the first collet and the second collet having cooperating tapering surfaces that force a portion of the first collet radially outward and a portion of the second collet radially inward when the second collet is pressed axially against the first collet.

9. The fitting of claim 1 wherein the at least first collet and the gland are captured within the nut while the nut is in the retracted position before ever being moved to the advanced position.

10. The fitting of claim 9 wherein the nut and gland have cooperating stop surfaces to retain the gland within the nut.

11. The fitting of claim 9 wherein one of the gland and nut includes a snap ring and the other of the gland and nut includes a stop surface to engage the snap ring to capture the gland and the at least first collet within the nut.

12. The fitting of claim 9 wherein the gland and nut have cooperating threads to retain the gland and the at least first collet within the nut when the nut is in the retracted position.

13. A fitting for connecting a conduit to another component, the fitting combining a collet-seal with the conduit and an O-ring face seal for connecting to the other component, the fitting comprising
a body adapted to connect to the other component and having a passage therethrough for carrying a fluid, the passage terminating at a generally flat first face transverse to the passage,
a gland having a passage therethrough for carrying a fluid and the passage terminating at a generally flat second face transverse to the passage, the first and second faces being proportioned to be positioned in sealing engagement with the passage through the gland in fluid communication with the passage through the body,
the gland having an internal passage for receiving an end portion of the conduit,
a collet assembly proportioned to surround the conduit and adapted to be squeezed into sealing engagement with the outside of the conduit,
a nut surrounding the gland and adapted to engage the body, to force the first face and second face into sealing engagement with each other, and to force the collet assembly into sealing engagement with the conduit and the internal passage in the gland, and wherein the collet assembly is captured by the gland and nut, and
wherein the body includes threads and the nut includes threads adapted to cooperate with the threads on the body to force the first face and second face into sealing engagement with each other and to force the collet assembly into sealing engagement with the conduit and the internal passage in the gland, and
wherein the nut and the gland include surfaces positioned to limit the distance the nut is retractable when the threads of the nut are disengaged from the threads of the body.

14. The fitting of claim 13 wherein the nut is retractable along the conduit from a position in which it engages the body to a position in which the first and second faces are free to slide transversely one with respect to the other.

15. (canceled)

16. The fitting of claim 15 wherein the threads on the body are external threads and the threads on the nut are internal threads.

17. The fitting of claim 13 wherein the collet assembly includes a single collet.

18. The fitting of claim 13 wherein the collet assembly includes a pair of collets.

19. (canceled)

20. The fitting of claim 13 wherein the surfaces on the nut and the gland comprise stop surfaces that engage each other to limit the distance the nut is retractable.

21. The fitting of claim 20 wherein the passage through the body and the passage through the gland define an axis, the gland and the nut each have an annular ridge, each ridge having a conical surface centered about the axis and one of the stop surfaces, the stop surfaces being more nearly normal to the axis and the stop surfaces being in contact with each other when the nut is at one axial limit of its movement.

22. The fitting of claim 21 wherein the conical surfaces of the annular ridges of the gland and nut engage each other and cause the gland and nut to elastically deform as the nut moves axially of the gland.

23. The fitting of claim 22 wherein the nut, prior to receipt of an end portion of the conduit in the internal passage of the gland and prior to the nut engaging the body, retains the collet assembly within a cavity defined by the nut and the gland and retains the gland at least partially within said cavity.

24. The fitting of claim 13 wherein one of the first and second faces includes an annular recess and the fitting includes a resilient O-ring disposed within the recess.
